(19) United States
(12) Patent Application Publication
(10) Pub. No.: US 2008/0166904 A1
(43) Pub. Date: Jul. 10, 2008

(54) Flexible cable for optical disk drive

(75) Inventors: Hsien-Chung Ou, Taoyuan (TW); Chen-Fu Chang, Taoyuan (TW); Li-Li Yang, Taoyuan (TW)

Correspondence Address: BACON & THOMAS, PLLC, 625 SLATERS LANE, FOURTH FLOOR, ALEXANDRIA, VA, 22314, US

(73) Assignee: QUANTA STORAGE INC., Taoyuan (TW)

(21) Appl. No.: 12/076,143

(22) Filed: Mar. 14, 2008

(30) Foreign Application Priority Data
Oct. 17, 2006 (TW) 095138293
Nov. 7, 2006 (CN) 200610144703.7

(51) Int. Cl. H01R 3/00

(52) U.S. Cl. 439/164

(57) ABSTRACT

A flexible cable for an optical disk drive is disposed at a case comprising an upper case and a lower case. The flexible cable comprises a fastening part fixed at the lower case and a moving part extended in the reverse direction of one end of the fastening part to form a beginning end fixed at the case. An intensive area comprised of elastic material is disposed at the surface of the beginning end and nearby the beginning end of the moving part. A smooth layer is disposed at the inside of the upper case and located on the moving path of the intensive area disposed at the moving part to be touched by the intensive area when the moving part is bent reversely. A secondary intensive area is disposed at the moving part, and is extended or separated from the intensive area, to prevent the flexible cable drooping.

### BACKGROUND OF THE INVENTION

1. Field of the Invention

The invention relates in general to an optical disk drive, and more particularly to a flexible cable connecting a tray and a main board in the optical disk drive for electronically connection and data transmission.

2. Description of the Related Art

In general, a flexible cable is utilized for electronically connecting to a tray which is movable and a main board which is fixed in an optical disk drive, for providing the power and the data transmitting of the electronic components on the tray. Thus, whether the flexible cable moving backwards and forwards can transmit signal stably affects the reliability of the optical disk drive.

Refer to FIG. 1, a schematic view of a conventional optical disk drive 10 is shown. The optical disk drive 10 comprises a hollow case 11 for accommodating a main board 12 and a tray 13. The main board 12 connects with one end of a fastening part 141 of a flexible cable 14. One end of a moving part 142 of the flexible cable 14 connects with a circuit board 15 located at below of the tray 13 for providing the power and the signal transmitting of a spindle motor 16 and a pick-up head 17. The tray 13 is capable of sliding out of the case 11 to provide changing a disk 18, or sliding into the case 11 to move to the play position. The spindle motor 16 is utilized for rotating the disk 18. The pick-up head 17 is controlled to move backwards and forwards along the radius direction of the disk 18 for reading or writing the data on the disk 18. And then, the data accessed by the pick-up head 17 is transmitted to the main board 12 to be processed through the circuit board 15 and the connecting of the flexible cable 14.

Because the flexible cable 14 is quite soft, the flexible cable 14 which is rubber becomes supple easily especially when in a high temperature operation. When the tray 13 slides out of the case 11, the moving part 142 droops to touch the case 11 easily. Thus, the flexible cable 14 is attrite and incapable of transmitting signal normally. In addition, the drooping moving part 142 wedged at the edge of the opening of the case 11 suffers harm from being jammed and obstructs the tray 13 from sliding into the case 11. In order to solve the above-mentioned problems, an intensive area 143 is formed on the drooping moving part 142 of the flexible cable 14 by applying a rubber layer or attaching Mylar in the conventional optical disk drive 10. Thus, the elasticity of the flexible cable 14 is increased and the support force for supporting the moving part 142 suspending is also enlarge, to avoid the flexible cable 14 drooping to touch the case 11 and suffering harm from being jammed.

However, the flexible cable 14 droops more easily because the total weight of the flexible cable 14 to which the intensive area 143 is added increases while its elasticity is not strong enough. Meanwhile, when the tray 13 slides into the case 11, the tray 13 pushes backwards the moving part 142, and the moving part 142 is subjected to a friction force, shown as the arrow in FIG. 1, caused by contact with the case 11. Thus, the moving part 142 resists the force which is generated from the tray 13 pushing backwards, and then it is resulted in that the front moving part 142 droops to touch the case 11 with attrition and suffers harm from being jammed. Therefore, the problems of the conventional flexible cable for an optical disk drive still exist and need to be solved.

### SUMMARY OF THE INVENTION

It is therefore an object of the invention to provide a flexible cable for an optical disk drive, and an intensive area of the flexible cable is disposed at a beginning end of a moving part in capable of supporting the flexible cable with elasticity. It reduces the load of the flexible cable and preventing the flexible cable from harm.

It is therefore another object of the invention to provide a flexible cable for an optical disk drive, wherein a smooth layer is disposed at where the case and the moving part of the flexible cable connect, for reducing the resisting force generated from the tray pushing backwards and decreasing the attrition.

According to a first aspect of the present invention, a flexible cable for an optical disk drive is provided. The flexible cable is disposed in a case of the optical disk drive. The case comprises an upper case and a lower case. The flexible cable comprises a fastening part and a moving part. The fastening part is fixed at the lower case. The moving part is extended in the reverse direction of one end of the fastening part to form a beginning end. The beginning end is fixed at the case. An intensive area comprised of elastic material is disposed at the surface of the beginning end and nearby the beginning end of the moving part. A smooth layer is disposed at the inside of the upper case and located at the moving path of the intensive area disposed at the moving part, so that the intensive area touched the smooth layer when the moving part is bent reversely. A secondary intensive area is disposed at the moving part. The secondary intensive area is extended from the intensive area or is separated from the intensive area.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic view of a conventional optical disk drive.

FIG. 2 is a schematic view of a flexible cable for an optical disk drive according to a first embodiment of this invention.

FIG. 3 is a schematic view of the flexible cable according to the first embodiment of this invention.

FIG. 4 is a schematic view of the action of the flexible cable.

FIG. 5 is a schematic view of a flexible cable for an optical disk drive according to a second embodiment of this invention.

FIG. 6 is a schematic view of a flexible cable for an optical disk drive according to a third embodiment of this invention.

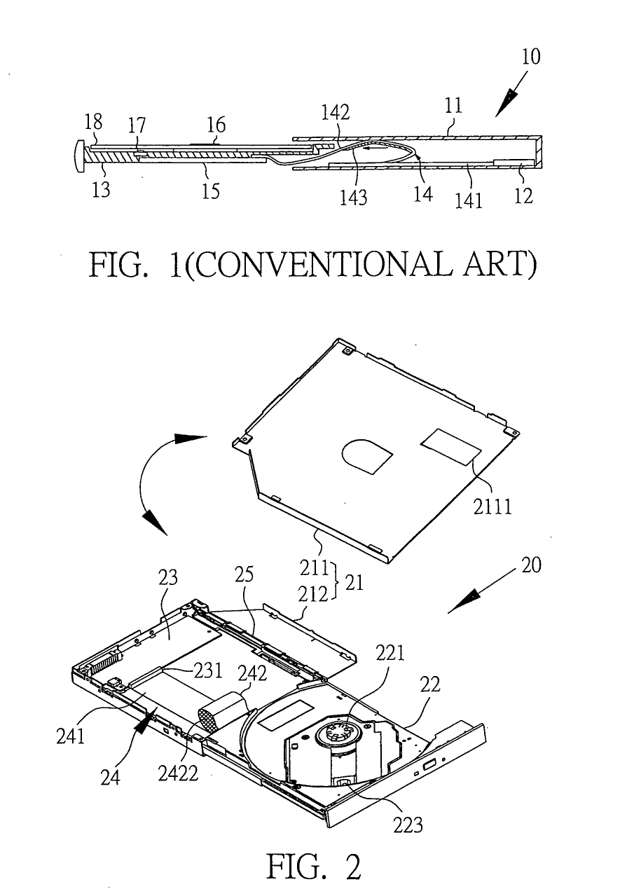

### DETAILED DESCRIPTION OF THE INVENTION

In order to achieve the purpose mentioned above, two embodiments are detailed described below. The invention will become apparent from the following detailed description of the preferred but non-limiting embodiments. The following description is made with reference to the accompanying drawings.

Referring to FIG. 2, a schematic view of a flexible cable for an optical disk drive 20 according to a first embodiment of the present invention is shown. The optical disk drive 20 comprises a case 21, a tray 22, a main board 23, and a flexible cable 24. The case 21 is hollow, and it allows the tray 22 to slide into and out of the case 21. One end of the flexible cable 24 is connected to the rear end of the tray 22, and the other end of the flexible cable 24 is connected to the main board 23 located at the rear end of the case 21. Thus, the flexible cable 24 still can transmit signal when the tray 22 moves relatively to the case 23.

The case 21 comprises an upper case 211 and a lower case 212. The upper case 211 and the lower case 212 form a hollow space. A smooth layer 2111 is disposed at the inside of the upper case 211. A rail 25 is disposed at two sides of the lower case 212 respectively and the main board 23 is disposed at the rear side of the lower case 212. A connecter 231 is disposed at the front end of the main board 23. Two sides of the tray 22 are supported by the two rails 25 for jutting in or out of the case 21, so as to provide changing or playing disks. A spindle motor 221 is disposed at the central of the tray 22, for rotating a disk 222 (shown in FIG. 4). A pick-up head 223 is disposed at the tray 22 and capable of moving along the radius direction of the disk 222 for reading or writing the data on the disk 222. And then, the spindle motor 221 and the pick-up head 223 are controlled by a circuit board 224 (shown in FIG. 4) located at below of the tray 22.

The flexible cable 24 of the first embodiment is a soft long flake cable, such as Flexible Flat Circuit. The flexible cable 24 is mainly divided into two parts; one part is a fastening part 241, and the other parts is a moving part 242. One end of the fastening part 241 is connected to the connecter 231 located at the front end of the main board 23, and the remaining of the fastening part 241 attaches to the surface of the lower case 212 along the direction of the slot of the connector 231. The way to fix the fastening part 241 could be pasting or riveting. The fastening part adhered to the lower case 212 could be extended up to the front opening of the case, and its length depends on the moving distance of the tray 22.

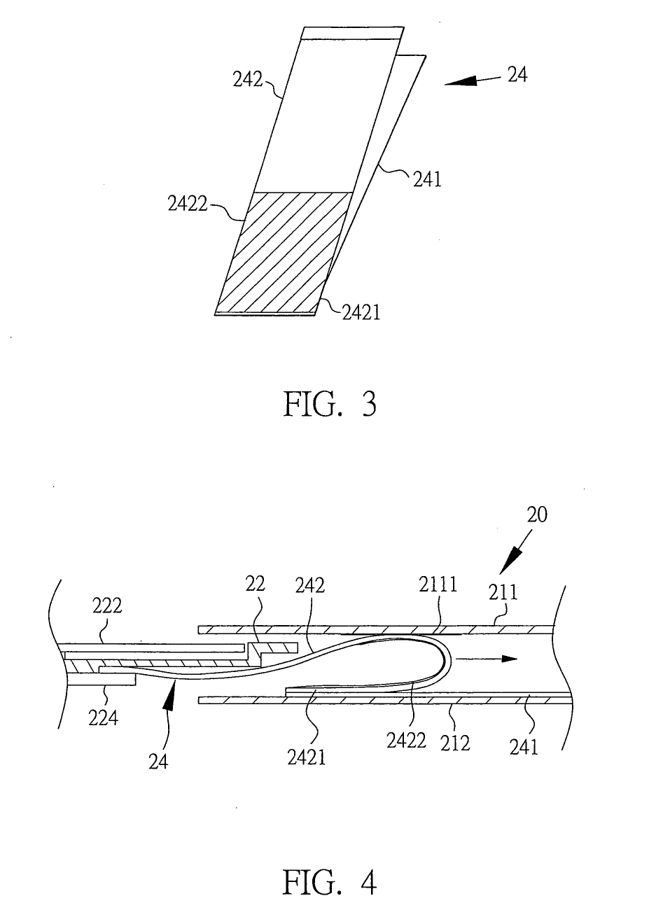

Furthermore, the moving part 242 is extended from one end, located at the front opening of the case 21, of the fastening part 241. The moving path of the moving part 242 passes the smooth layer 2111 disposed at the upper case 211. Refer to FIG. 3 at the same time, a schematic view of the flexible cable 24 according to the first embodiment of this invention is shown. The moving part 242 is bent reversely to the inward of the case 21. A beginning end 2421 of the moving part 242 is stacked and fixed on the upper surface of the fastening part 241, and the part, following the beginning end 2421, of the moving part 242 is not fixed but suspended inward over the fastening part 241. An intensive area 2422 is disposed at the surface of the beginning end 2421 and nearby the beginning end 2421. The way to form the intensive area 2422 could be coating or attaching a rubber layer, Mylar or an intensive flake which are comprised of elastic material. The other end of the moving part 242 is bent to connect the rear side of the tray 22, that is, the end of the moving part 242 connects the circuit board 224 located at the bottom of the tray 22. Thus, the main board 23 is electronically connected to the circuit board 224 via the flexible cable 24. The length of the moving part 242 is also determined according to the moving distance of the tray 22, wherein the length is just right for the tray 22 to move to the play position. If the moving part 242 is too long, it will interfere with the operation of the optical disk drive.

Refer to FIG. 4, a schematic view of the action of the flexible cable 24 is shown. When the tray 22 is located at outside of the optical disk drive 20, one end, connecting to the tray 22, of the moving part 242 is guided to be bent reversely and jut out. Meanwhile, the area being bent reversely is located just right at the intensive area 2422 which is disposed at the beginning end 2421 of the moving part 242. One end of the intensive area 2422 with the moving part 22 is fixed on the upper surface of the fastening part 241, and the intensive area has strong elasticity. Thus, the gravity of the intensive area 2422 and the moving part 242 can be counteracted to avoid the drooping moving part 242. Also, the elastic intensive area 2422 being bent generates a force (shown as the arrow in FIG. 4) which tends to make the bent area stretch backward and revert to straight and make the moving part 242 stretch backward, so as to prevent the flexible cable 24 from drooping and being attrite and also prevent the tray 22 from wedging and harming the flexible cable 24. Thus, the tray 22 can slide into the optical disk drive 20 smoothly.

Furthermore, the smooth layer 2111 of the upper case 211 is located at the moving path of the intensive area 2422, so that the intensive area 2422 touches the smooth layer 2111 of the upper case 211 when the intensive area 2422 is bent reversely. Due to the feature that the smooth layer 2111 has a low friction factor, the frictional resistance of the case 211 against the moving part 242, especially against the softened flexible cable 24 under high temperature, can be reduced. Meanwhile, the moving part 242 is stretched reversely by the bent intensive area 2422 of elasticity and also driven by the backward pushing force of the tray, so that the moving part 242 moved with the tray 22 and enter the optical disk drive 20 smoothly.

Therefore, in the flexible cable for an optical disk drive of the present invention, the intensive area having stronger elasticity is appropriately disposed at the beginning end of the moving part of the flexible cable. The elasticity of the intensive area supports the weight of the intensive area and the flexible cable. In addition, the force, which is generated by bending the intensive area and tends to spring backward to straight, guides the moving part backward and makes the moving part of the flexible cable be straight. Thus, it is avoidable for the moving part from drooping when the moving part juts out of the optical disk drive with the tray, so as to support the load of the flexible cable and prevent the flexible cable from suffering harm which is caused by being jammed and attrite. Furthermore, in the flexible cable for an optical disk drive of the invention, the smooth layer is disposed the case connects to the moving part of the flexible cable, for reducing the resisting force of the case against the flexible cable. Besides, with the motive force which is generated from the bending intensive area and guides the moving part backward, and with the motive force which is generated by the tray pushing backward, the flexible cable can jut into the optical disk drive smoothly.

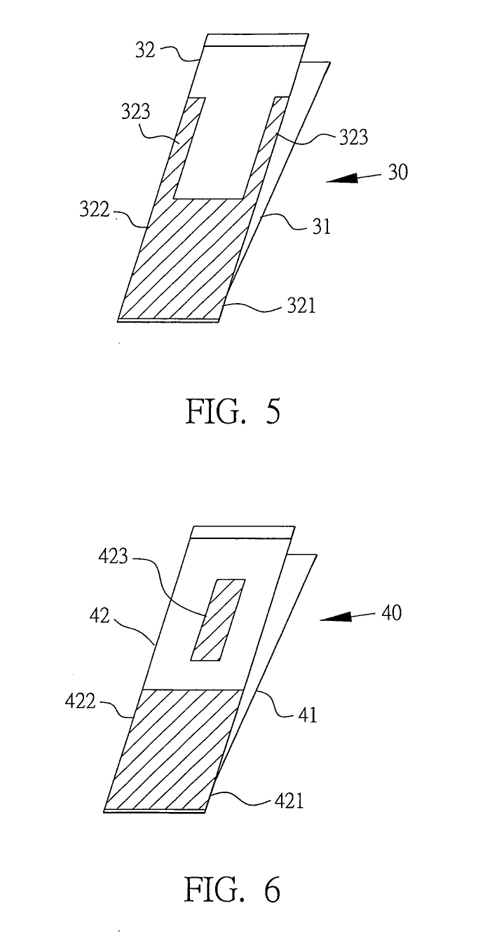

Refer to FIG. 5, a schematic view of a flexible cable 30 for an optical disk drive according to a second embodiment of this invention is shown. The connection and the basic structure of the flexible cable 30 and the optical disk drive are similar to the flexible cable 24 for an optical disk drive in the first embodiment of this invention. The flexible cable 30 is also a soft long flake cable and mainly divided into two parts; one end is a fastening part 31 and other end is a moving part 32. The moving part 32 is extended from one end of the fastening part 31. A beginning end 321 of the moving part 32 is stacked and fixed on the upper surface of the fastening part 31, and the part, following the beginning end 321, of the moving part 32 is suspended over the fastening part 31 without fixing. An intensive area 322 is disposed at the nearby surface of the beginning end 321. A secondary intensive area 323 is formed by extending the intensive area 322 along two sides of the moving part 32. Thus, besides that the purpose of the first embodiment can be achieved, the elasticity of the flexible cable 30 is further increased to prevent the flexible cable 30 from drooping, and the weight of the intensive area is decreased.

Refer to FIG. 6, a schematic view of a flexible cable 40 for an optical disk drive according to a third embodiment of the present invention is shown. The connection and the basic structure of the flexible cable 40 and the optical disk drive are similar to the flexible cable 24 for an optical disk drive in the first embodiment of this invention. The flexible cable 40 is also a soft long flake cable and mainly divided into two parts; one end is a fastening part 41 and other end is a moving part 42. The moving part 42 is extended from one end of the fastening part 41. A beginning end 421 of the moving part 42 is stacked and fixed on the upper surface of the fastening part 41, and the part, following the beginning end 421, of the moving part 42 is not fixed but suspended inward over the fastening part 41. An intensive area 422 is disposed at the nearby inner surface of the beginning end 421, and a secondary intensive area 423 is disposed separately from the intensive area 422. The intensive area 422 touches the upper case and the smooth layer when the moving part 42 is bent reversely, so as to reduce the frictional resistance of the flexible cable 40 against the upper case. Thus, besides that the purpose of the above-mentioned embodiment can be achieved, the intensive area 422 further enhances the anti-attrition efficacy of the flexible cable 40.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flexible cable adapted for an optical disk drive, disposed in a case of the optical disk drive, the flexible cable comprising:
a fastening part fixed at the case;
a moving part extended in the reverse direction of one end of the fastening part to form a beginning end, the beginning end fixed at the case; and
an intensive area comprised of elastic material and disposed at the surface of the beginning end and nearby the beginning end of the moving part.

2. The flexible cable for an optical disk drive according to claim 1, wherein the intensive area is disposed at the outer surface of the beginning end and nearby the beginning end.

3. The flexible cable for an optical disk drive according to claim 1, wherein the intensive area is disposed at the inner surface of the beginning end and nearby the beginning end.

4. The flexible cable for an optical disk drive according to claim 1, wherein the intensive area is formed by applying a rubber layer which is comprised of elastic material.

5. The flexible cable for an optical disk drive according to claim 4, wherein the rubber layer is Mylar.

6. The flexible cable for an optical disk drive according to claim 1, wherein the intensive area is formed by attaching an intensive flake which is comprised of elastic material.

7. The flexible cable for an optical disk drive according to claim 1, wherein the optical disk drive comprises an opening, and the beginning end is extended from one end of the fastening part close to the opening.

8. The flexible cable for an optical disk drive according to claim 1, wherein the flexible cable is a long flake of Flexible Flat Circuit.

9. The flexible cable for an optical disk drive according to claim 1, wherein the beginning end is fixed on the fastening part, and the moving part following the beginning end is suspended over the fastening part.

10. The flexible cable for an optical disk drive according to claim 9, wherein the optical disk drive further comprises a tray movable into and out of the case, and the other end of the moving part following the beginning end is connected thereto.

11. The flexible cable for an optical disk drive according to claim 1, wherein a smooth layer is disposed at the inside of the case and located on the moving path of the moving part.

12. The flexible cable for an optical disk drive according to claim 11, wherein the smooth layer is located on the moving path of the intensive area of the moving part, so that the intensive area touches the smooth layer when the moving part is bent reversely.

13. The flexible cable for an optical disk drive according to claim 11, wherein the smooth layer has a low friction factor.

14. The flexible cable for an optical disk drive according to claim 1, wherein a secondary intensive area is disposed at the moving part.

15. The flexible cable for an optical disk drive according to claim 14, wherein the secondary intensive area is extended from the intensive area.

16. The flexible cable for an optical disk drive according to claim 15, wherein the secondary intensive area is extended from the intensive area along two sides of the moving part.

17. The flexible cable for an optical disk drive according to claim 14, wherein the secondary intensive area is separated from the intensive area.

18. An optical disk drive comprising:
a case having an opening;
a flexible cable disposed in the case and comprising a fastening part and a moving part, wherein the fastening part is fixed at the case and extended from the inside of the case toward the opening, the moving part is extended in the reverse direction of one end of the fastening part close to the opening to form a beginning end fixed at the case, and the part following the beginning end is movable; and
a smooth layer disposed at the inside of the case and located on the moving path of the moving part.

19. The optical disk drive according to claim 18, wherein the smooth layer has a low friction factor.

20. The optical disk drive according to claim 18, wherein the case comprises a upper case and a lower case, the fastening part is fixed at the lower case, and the smooth layer is fixed at the upper case.
